(19) United States
(12) Patent Application Publication
(10) Pub. No.: US 2025/0196309 A1
(43) Pub. Date: Jun. 19, 2025

(54) Nose Cap for a Power Tool Having a Wrench

(71) Applicant: Robert Bosch GmbH, Stuttgart (DE)

(72) Inventors: Ralph Kamarski, Inverness, IL (US); Audel Gutierrez, Aurora, IL (US); Samantha Wojtowicz, Rolling Meadows, IL (US); Saurabh Nanavati, Westmont, IL (US)

(21) Appl. No.: 18/967,888

(22) Filed: Dec. 4, 2024

Related U.S. Application Data
(60) Provisional application No. 63/611,901, filed on Dec. 19, 2023.

(51) Int. Cl. B25F 5/02; B25B 21/00; B25B 23/18

(52) U.S. Cl. CPC B25F 5/02; B25B 21/00; B25B 23/18

(57) ABSTRACT

A nose cap for a power tool, the power tool comprising: a housing extending along and defining an axial direction, the power tool further including a front portion at a first axial end of the housing, a spindle extending along the axial direction and protruding from said front portion. The nose cap is configured to be removably attached to the front portion and from which the spindle further protrudes. The nose cap defines a central axis and comprises a wrench. The wrench has an accessory engaging portion extending across the central axis having a U shape.

### TECHNICAL FIELD

The present disclosure relates to power tools, such as rotary tools.

### BACKGROUND

Power tools, such as rotary tools are a favorite instrument of professional craftsmen, handymen, homeowners, and hobbyists. The typical rotary tool is a handheld power tool configured for use with a variety of accessory bits/tools that can be used for cutting, carving, sanding, polishing, and many other applications, referred to collectively as cutting operations. One specific example of a rotary tool is the DREMEL® rotary tool sold by the Robert Bosch Tool Corporation.

Many rotary tools include a collet assembly coupled to the drive shaft of an electric motor. The collet assembly is configurable to couple or to decouple an accessory bit to the drive shaft of the electric motor. The electric motor is operable to rotate the collet assembly and any accessory bit coupled thereto. The accessory bit may be removed and replaced with a different accessory bit when the accessory bit becomes nonfunctional or when the user desires to perform a different cutting operation. Typically, a collet tool is provided to loosen or tighten the collect assembly. The DREMEL® EZ Twist™ Nose Cap may be used as such a collet tool. The EZ Twist™ Nose Cap also provides a good grip of the rotary tool close to its accessory bit. EZ Twist™ nose cap has an integrated wrench for fast accessory changes. It is always handy because it is already on the tool. It can be used on all rotary tools with a corresponding threaded nose piece. Its soft grip provides additional comfort.

It would be desirable to further enhance such a power tool and its nose cap.

### SUMMARY

An aspect of the disclosure is directed towards a nose cap for a power tool, the power tool comprising: a housing extending along and defining an axial direction, the power tool further including a front portion at a first axial end of the housing, a spindle extending along the axial direction and protruding from said front portion, wherein the nose cap is configured to be removably attached to the front portion and from which the spindle further protrudes, wherein the nose cap defines a central axis, wherein the nose cap comprises a wrench, and wherein the wrench has an accessory engaging portion extending across the central axis having a U shape.

In another aspect, the accessory engaging portion encloses less than 360 degrees.

In another aspect, the wrench has a thickness that extends in a direction which is parallel to the central axis and has a width that extends in a direction across the central axis, and wherein the thickness is bigger than the width.

In another aspect, the wrench has a base portion extending between a first side portion and a second side portion and the first side portion and the second side portion are parallel to each other.

In another aspect, the first side portion has a first end portion on a first end facing away from the base portion and the second side portion has a second end portion on a first second end facing away from the base portion, and wherein the first end portion and the second end portion face away from each other.

In another aspect, the wrench has a base portion extending between a first side portion and a second side portion and the first side portion and the second side portion are parallel to each other, wherein the wrench has a first extension, a second extension and a third extension each radially extending away from the central axis and beyond an outer circumference of the wrench, wherein the first extension extends away from the first side portion, wherein the second extension extends away from the second side portion, and wherein the third extension extends away from the base portion.

In another aspect, the wrench has an accessory engaging portion extending across the central axis and the wrench defines an outer circumference with two flat surfaces that are parallel to each other, wherein the wrench has two notches extending from the outer circular circumference of the wrench towards a center of the wrench, and wherein, along the outer circumference. the notches are arranged between the two flat surfaces.

In another aspect, the nose cap comprises a transparent tubular body extending along the central axis.

In another aspect, a light is arranged in the nose cap, wherein the nose cap comprises an opaque sleeve extending along the central axis and a circumference of the transparent tubular body, and wherein a rear end of the nose cap facing a front portion of a power tool/housing is opaque so that light from the nose cap exits at a front end of the nose cap which is arranged opposite from the front portion.

In another aspect, a light is arranged in the nose cap, wherein the nose cap comprises an opaque sleeve extending along the central axis and a circumference of the transparent tubular body, and wherein a rear end of the nose cap facing a power tool/housing is opaque so that light from the nose cap exits at a front end of the nose cap which is arranged opposite from the front portion.

In another aspect, the nose cap comprises an opaque sleeve extending along the central axis along and a circumference of the transparent tubular body so that light entering the nose cap from a front portion of a tool can exit at a front end of the nose cap which is arranged opposite from the front portion.

The above aspects of this disclosure and other aspects will be explained in greater detail below with reference to the attached drawings.

### BRIEF DESCRIPTION OF THE DRAWINGS

FIG. 1 is a perspective view of a part of a power tool with a nose cap;

FIG. 2 is a perspective view of a first embodiment of the nose cap of FIG. 1;

FIG. 3 is a front view of the nose cap of FIG. 2;

FIG. 4 is a perspective view of a second embodiment of a nose cap;

FIG. 5 is a front view of the nose cap of FIG. 4;

FIG. 6 is a perspective view of a third embodiment of a nose cap; and

FIG. 7 is a front view of the nose cap of FIG. 6.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

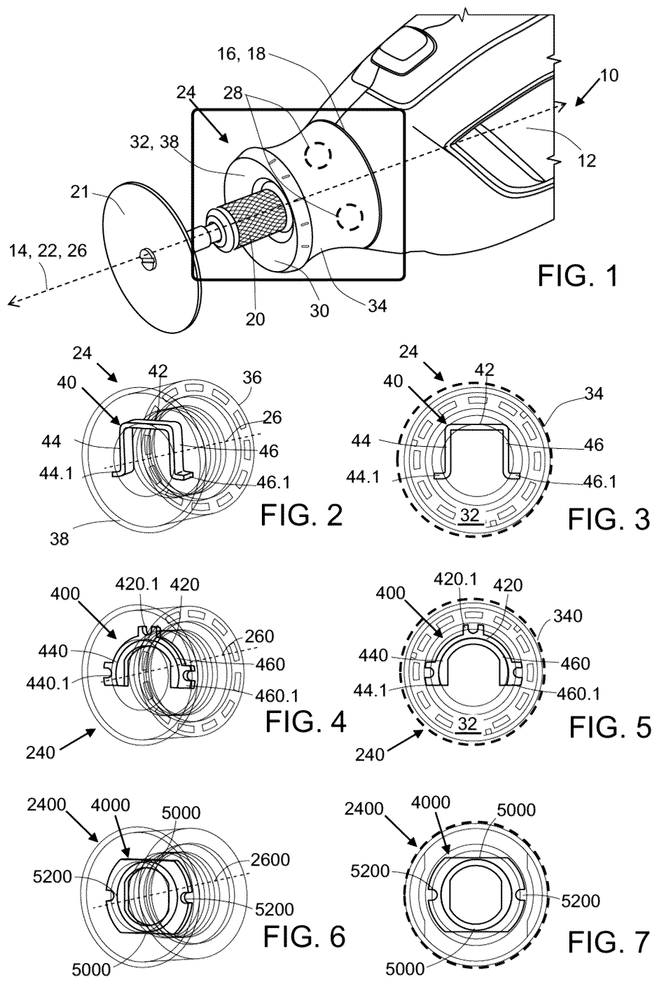

FIG. 1 shows a rotary tool 10. Instead of the depicted rotary tool 10 the disclosure may also apply to another power tool such as an oscillating tool, a saw, a brush, drill, a driver, a drill/driver, a rotary hammer, or a wrench. The rotary tool 10 comprises a housing 12 extending along an axial direction 14. The housing 12 contains a motor activated with a trigger (both not depicted). The rotary tool 10 and/or housing 12 includes a front portion 16 at a first axial end 18 of the rotary tool 10. The rotary tool 10 further comprises a spindle 20. An accessory 21, in the present case a grinding wheel, is attached to the spindle 20. The accessory 21 may also be a cutting disk or buffing wheel etc. The spindle 20 defines an axis of rotation 22 extending along the axial direction 16 and aligned with the front portion 16.

A clear nose cap 24 is removably attached to the front portion 16. The spindle 20 protrudes further from the nose cap 24. The nose cap 24 extends in an axial direction 14 and has a central axis 26 extending along the axial direction 16. The axis 26 of the nose cap is aligned with the axis of rotation 22 of the spindle 20. The nose cap 24 is generally of cylindrical shape. For a better grip for a user the nose cap 24 may have a grip portion on the outside. The grip portion may have a smaller diameter in the middle and a larger diameter at the longitudinal ends of the nose cap 24.

The nose cap 24 is affixed to the front portion 16 by twisting the nose cap 24 in a first rotary direction. The nose cap 24 is removed from the front portion 16 by twisting the nose cap 24 in a second rotary direction opposite from the first rotary direction. An electrically powered work light 28 is contained in the nose cap 24 and powered by a power source of the rotary tool 10. The work light 28 is depicted by two dashed circles symbolizing two individual lights but it could be just one or more than two. The power source is integrated in the housing 12 and activated by the trigger mentioned above. That power source also supplies the motor of the rotary tool 10. The work light 28 illuminates a work area in front of the rotary tool. The work light 28 is arranged at a nose cap 24 front end 30 which extends transversely to the axial direction 14.

As shown in more detail in FIGS. 2 and 3, the nose cap 24 comprises a transparent tubular body 32. The tubular body 32 may be made from a clear polycarbonate or similar material. With proper orientation of the clear nose cap 24 light may be transmitted for maximum luminosity. An opaque sleeve 34 (only hinted at in dashed lines in FIG. 3) extends along the axial direction 14 and along a circumference of the transparent tubular body 32. A rear end 36 of the of the nose cap 24 is opaque so that light from the work light 28 in the nose cap 24 only exits at a front end 38 of the nose cap 24 which is arranged opposite from the front portion 16. The rear end 36 may also be clear in which case light could also exit at the rear end 36.

As an alternative, the rotary tool 10 may comprise a work light 28 arranged at the front portion 16 of the housing 14. The depiction would be the same as in FIG. 1. The nose cap 24 then also comprises an opaque sleeve 34 extending along the axial direction 14 and along the circumference of the transparent tubular body 32. In this case, the rear end 36 of the nose cap 24 is clear so that light from the work light 28 in the front portion 16 enters through the clear rear end 36 and exits at a front end 38 of the nose cap 24.

The nose cap 24 comprises a wrench 40 made from a metal and is therefore opaque. The wrench 40 has a thickness that extends in a direction which is parallel to the axial direction 14 and has a width that extends in a direction across the axial direction 14. The thickness is bigger than the width. The wrench 40 has an accessory engaging portion extending across the first axial direction and having a U shape The accessory engaging portion encloses less than 360 degrees, in the present example approximately 270 degrees. The accessory engaging portion may engage an accessory directly or via e.g. a collet nut.

The wrench 40 has a base portion 42 extending between a first side portion 44 and a second side portion 46. The first side portion 44 and the second side portion 46 are parallel to each other and spaced so as to grip two complementary surfaces of a collet nut for the spindle 20. This enables tightening or loosening of the accessory 21. The first side portion 44 has a first end portion 44.1 on a first end facing away from the base portion 42 and the second side portion 46 has a second end portion 46.1 on a first second end facing away from the base portion 42. The first end portion 44.1 and the second end portion 46.1 face away from each other. This design reduces the material blocking light being transmitted through the nose cap 24.

A nose cap 240 shown in FIGS. 4 and 5, comprises a wrench 400. The wrench 400 has a base portion 420 extending between a first side portion 440 and a second side portion 460. The first side portion 440 and the second side portion 460 are parallel to each other. The wrench 400 has a first extension 440.1, a second extension 460.1 and a third extension 420.1 each radially extending away from the central axial 260 of the nose cap 400 and beyond an outer circumference of the wrench 400. The first extension 440.1 extends away from the first side portion 440, the second extension 460.1 extends away from the second side portion 460, and the third extension 420.1 extends away from the base portion 420. The first extension 440.1, the second extension 440.1 and the third extension 420.1 each have a semicircular notch extending towards central axis 260. This increases surfaces area with the nose cap 240. The nose cap 240 has a transparent tubular body and an opaque sleeve 340.

A nose cap 2400 shown in FIGS. 6 and 7 includes a wrench 4000. The wrench 4000 has an accessory engaging portion extending across a central axis 2600. The wrench 4000 defines an outer circumference with two flat surfaces 5000 that are parallel to each other. The wrench 4000 has two notches 5200 extending from the outer circular circumference of the wrench 4000 towards the center or central axis 2600 of the wrench 4000. Along the outer circumference of the wrench 4000 the notches 5200 are arranged between the two flat surfaces 5000.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected. The words used in the specification are words of description rather than limitation, and it is understood that various changes may be made without departing from the spirit and scope of the disclosure as claimed. The features of various implementing embodiments may be combined to form further embodiments of the disclosed concepts.

1. A nose cap for a power tool, the power tool comprising: a housing extending along and defining an axial direction, the power tool further including a front portion at a first axial end of the housing, a spindle extending along the axial direction and protruding from said front portion, wherein the nose cap is configured to be removably attached to the front portion and from which the spindle further protrudes, wherein the nose cap defines a central axis, wherein the nose cap comprises a wrench, and wherein the wrench has an accessory engaging portion extending across the central axis having a U shape.

2. The power tool according to claim 1, wherein the accessory engaging portion encloses less than 360 degrees.

3. The power tool according to claim 1, wherein the wrench has a thickness that extends in a direction which is parallel to the central axis and has a width that extends in a direction across the central axis, and wherein the thickness is bigger than the width.

4. The power tool according to claim 1, wherein the wrench has a base portion extending between a first side portion and a second side portion and the first side portion and the second side portion are parallel to each other.

5. The power tool according to claim 4, wherein the first side portion has a first end portion on a first end facing away from the base portion and the second side portion has a second end portion on a first second end facing away from the base portion, and wherein the first end portion and the second end portion face away from each other.

6. The power tool according to claim 1, wherein the wrench has a base portion extending between a first side portion and a second side portion and the first side portion and the second side portion are parallel to each other, wherein the wrench has a first extension, a second extension and a third extension each radially extending away from the axial direction and beyond an outer circumference of the wrench, wherein the first extension extends away from the first side portion, wherein the second extension extends away from the second side portion, and wherein the third extension extends away from the base portion.

7. The power tool according to claim 1, wherein the wrench has an accessory engaging portion extending across the central axis and the wrench defines an outer circumference with two flat surfaces that are parallel to each other, wherein the wrench has two notches extending from the outer circular circumference of the wrench towards a center of the wrench, and wherein, along the outer circumference. the notches are arranged between the two flat surfaces.

8. The power tool according to claim 1, wherein the nose cap comprises a transparent tubular body extending along the central axis.

9. The power tool according to claim 1, wherein a light is arranged in the nose cap, wherein the nose cap comprises an opaque sleeve extending along the central axis and a circumference of the transparent tubular body, and wherein a front portion of the nose cap is opaque so that light from the nose cap exits at a front end of the nose cap which is arranged opposite from the front portion.

10. The power tool according to claim 1, wherein the nose cap comprises an opaque sleeve extending along the central axis along and a circumference of the transparent tubular body so that light entering the nose cap from a front portion of a tool can exit at a front end of the nose cap which is arranged opposite from the front portion.
